(19) United States
(12) Patent Application Publication
(10) Pub. No.: US 2026/0065586 A1
(43) Pub. Date: Mar. 5, 2026

(54) RENDERING CONTROLLER CONFIGURED TO RENDER LIGHTS IN THREE-DIMENSIONAL SCENE AND METHOD FOR THE SAME

(71) Applicant: Huawei Cloud Computing Technologies Co., Ltd., ,Guizhou (CN)

(72) Inventors: Alexis Crickx, Munich (DE); Alexander Weinrauch, Graz (AT); Wolfgang Tatzgern, Graz (AT); Markus Steinberger, Munich (DE)

(73) Assignee: Huawei Cloud Computing Technologies Co., Ltd., ,Guizhou (CN)

(21) Appl. No.: 19/383,238

(22) Filed: Nov. 7, 2025

Related U.S. Application Data
(63) Continuation of application No. PCT/EP2023/062899, filed on May 15, 2023.

(51) Int. Cl. G06T 15/80; G06T 1/60; G06T 15/04

(52) U.S. Cl. CPC G06T 15/80; G06T 1/60; G06T 15/04

(57) ABSTRACT

A rendering controller configured to render lights in a three-dimensional (3D) scene is disclosed. The 3D scene includes one or more objects. Each object is associated with a plurality of on-surface reservoirs. The rendering controller is further configured to provide light transport computation in texture space utilizing resampled importance sampling (RIS) or weighted reservoir sampling (WRS) based on the on-surface caches. The rendering controller is configured to compute shading efficiently (i.e., direct, and indirect illumination) of the 3D scene in multi-viewer applications present in the cloud, which involves complex lighting scenarios.

### CROSS-REFERENCE TO RELATED APPLICATIONS

This application is a continuation of International Application No. PCT/EP2023/062899, filed on May 15, 2023, the disclosure of which is hereby incorporated by reference in its entirety.

### TECHNICAL FIELD

The present disclosure relates generally to the field of virtual environments and, more specifically, to a rendering controller configured to render lights in a three-dimensional (3D) scene and a method for use in the rendering controller.

### BACKGROUND

Typically, with the development of three-dimensional (3D) technologies, a 3D virtual environment has become widespread. The 3D virtual environment provides new ways to virtually explore a 3D-designed virtual place, such as a 3D meeting room, a 3D classroom, a 3D museum, and the like. The 3D virtual environment is also used for playing video games or for virtual events, for example, a video conferencing. In the 3D virtual environment, 3D scenes are rendered through one or more viewpoints. For example, in 3D video games operating on the 3D virtual environment, a large number of players or viewers look at the same 3D scene from different locations with different views. In such a scenario, there is a possibility of a partial or complete overlap of views from the multiple viewers. In the 3D virtual environment, rendering is performed to create a final visual appearance of the 3D scene in the form of a two-dimensional (2D) image. The appearance of the surface of the 3D scene is created by using one or more virtual light sources, which illuminates different points on the 3D scene to generate a photorealistic 2D image during rendering. Conventionally, complex computations are required to determine the appearance of the surface of each 3D scene in the 3D virtual environment. Further, global light transport is required to determine an amount of light coming towards each point of a viewed surface of the 3D scene. Furthermore, complex material models are evaluated along with multiple effects, which contribute to a final appearance of each 3D scene in the 3D virtual environment. However, in the case of complex lighting scenarios in which the 3D virtual environment is having a large number of moving light sources, the computation of the impact of all the moving light sources during rendering becomes expensive.

Currently, certain attempts have been made to solve the problem of computation of multiple moving light sources while rendering in the 3D virtual environment by taking separate instances of applications running in the cloud, which is configured along with the 3D virtual environment. Each instance communicates with a central server in the cloud to receive updates of the 3D virtual environment or receive a data that is required for 2D image generation, such as the geometry, lighting configuration, physics updates, and the like. Each instance independently computes the appearance of all visible screen fragments of each viewer and streams the resulting image on a display. Each client's rendering is driven by a current view location and focuses on a screen space of each viewer. In other words, the rendering is driven from an output side, for example, tracing rays or paths into the 3D scene from a current view of each individual client and computing special effects in the screen space, like screen-space ambient occlusion, and the like. Such a conventional approach leads to individual and independent rendering computations of the same 3D scene for each viewer. Furthermore, in order to estimate shading in the complex lighting scenarios, a typical statistical technique, for example, an importance sampling, is used. The conventional importance sampling technique mainly focuses on selecting the best samples for the estimation of integrand of a rendering equation (i.e., picking samples in a probability distribution that approximates the distribution of an incoming light and/or the material response of the shaded point). Conventionally, certain statistical methods are used to retain the most meaningful light samples for direct and indirect illumination estimations. However, the problem with the statistical methods is that the screen-space nature of such methods involves a technical challenge to share and reuse computations across different viewers in order to use the finest light samples for different viewers or purposes. Furthermore, the statistical methods rely on a cost-intensive temporal reprojection (i.e., using motion vectors) to account for camera movements and on spatial neighbor filtering (e.g., to check if sampled points are on the same surface) to produce consistent and efficient spatio-temporal resampling. Due to which, there exists a technical problem of how to efficiently compute shading (i.e., direct, and indirect illumination) of the 3D scene in multi-viewer applications present in the cloud, which involves complex lighting scenarios.

Therefore, in light of the foregoing discussion, there exists a need to overcome the aforementioned drawbacks associated with conventional methods of computing shading in complex lighting scenarios.

### SUMMARY

The present disclosure provides a rendering controller configured to render lights in a three-dimensional (3D) scene and a method for use in the rendering controller. The present disclosure provides a solution to the existing problem of how to efficiently compute shading (i.e., direct, and indirect illumination) of the 3D scene in multi-viewer applications present in the cloud, which involves complex lighting scenarios. An aim of the present disclosure is to provide a solution that overcomes at least partially the problems encountered in the prior art and provides a rendering controller configured to render lights in a 3D scene and a method for use in the rendering controller which involves on-surface weighted reservoir resampling for sharing lighting computations across time and space in multi viewer scenarios.

One or more objectives of the present disclosure are achieved by the solutions provided in the enclosed independent claims. Advantageous implementations of the present disclosure are further defined in the dependent claims.

In one aspect, the present disclosure provides a rendering controller configured to render lights in a 3D scene comprising one or more objects, wherein each object is associated with a plurality of on-surface reservoirs, wherein the rendering controller is further configured to provide light transport computation in texture space utilizing resampled importance sampling (RIS) or weighted reservoir sampling (WRS) based on the on-surface caches.

The rendering controller is configured to compute shading efficiently (i.e., direct, and indirect illumination) of the 3D scene in multi-viewer applications present in the cloud, which involves complex lighting scenarios. The rendering controller is used to render the lights in the 3D scene that includes the one or more objects, such as by applying the RIS or the WRS on the on-surface reservoirs to enable efficient single and multi-viewer direct and indirect light sampling. The rendering controller provides on-surface weighted reservoir resampling (i.e., ‘timeless’ resampling) for sharing lighting computations across time and space in multi viewer scenarios. In other words, the rendering controller shoots rays for the on-surface weighted reservoir resampling without a frame time, as the on-surface-space reservoir does not change location over time, and sampling can happen at any point. In addition, the rendering controller is configured to store the on-surface reservoirs in on-surface caches, such as the plurality of on-surface reservoirs living directly on the surface of the objects. Beneficially as compared to in screen space, the continuous on-surface-space reservoir allows to perform the RIS with unseen surrounding surface points. The rendering controller can directly query neighboring reservoirs. Moreover, if multiple viewers or rays from other different sources hit the same surface point, then the reservoir sampling can be used to guide light sampling from the location. Therefore, there is no need for checking whether the surrounding points fulfill any depth threshold, and the like.

In another aspect, the present disclosure provides a method for a rendering controller configured to render lights in a 3D scene comprising one or more objects, wherein each object is associated with a plurality of on-surface reservoirs, wherein the method comprises providing light transport computation in texture space utilizing RIS, or WRS based on the on-surface caches.

The method achieves all the advantages and technical effects of the rendering controller of the present disclosure.

It is to be appreciated that all the aforementioned implementation forms can be combined. It is to be noted that all devices, elements, circuitry, units, and means described in the present application could be implemented in the software or hardware elements or any kind of combination thereof. All steps which are performed by the various entities described in the present application, as well as the functionalities described to be performed by the various entities, are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Like elements have been indicated by identical numbers.

Embodiments of the present disclosure will now be described, by way of example only, with reference to the following diagrams wherein:

FIG. 1 is a block diagram of a rendering controller, in accordance with an embodiment of the present disclosure;

FIG. 2 is a flowchart of a method for a rendering controller configured to render lights in a three-dimensional (3D) scene, in accordance with an embodiment of the present disclosure;

FIG. 3 is a diagram that depict exemplary scenario of screen-space reservoirs and surface space reservoirs in an on-surface weighted reservoir resampling (OSWRR) technique respectively, in accordance with an embodiment of the present disclosure;

FIG. 4 is a diagram that depicts an exemplary scenario of on surface cache reservoirs in an OSWRR technique for performing direct lighting estimation, in accordance with an embodiment of the present disclosure;

FIG. 5 is an exemplary diagram that depicts an exemplary scenario of an application of an OSWRR technique for global illumination estimation, in accordance with an embodiment of this disclosure;

FIG. 6 shows an exemplary diagram that depicts an exemplary scenario of an application of an OSWRR technique to path guiding, in accordance with an embodiment of this disclosure; and

FIG. 7 shows an exemplary diagram that depicts an exemplary scenario of an application of an OSWRR for multiple bounce global illumination computation, in accordance with an embodiment of this disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that there are various other embodiments for carrying out or practicing the present disclosure.

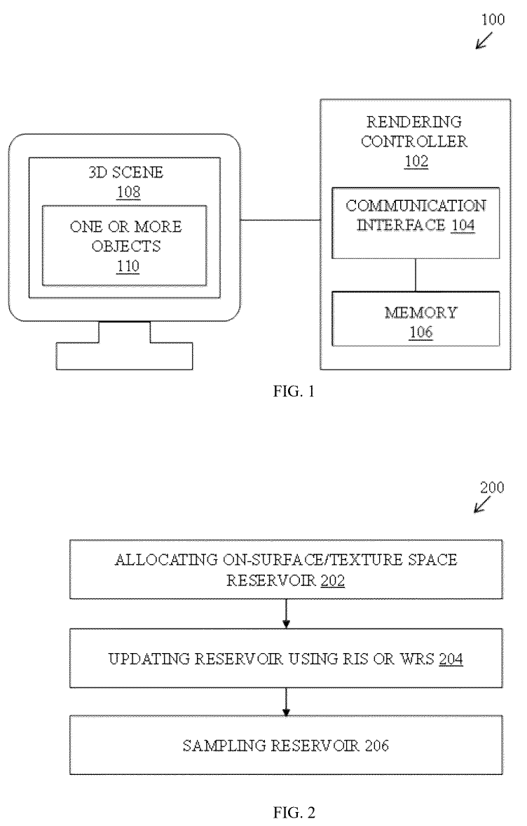

FIG. 1 is a block diagram of a rendering controller, in accordance with an embodiment of the present disclosure. With reference to FIG. 1, there is shown a block diagram 100 of a rendering controller 102 that includes a communication interface 104 and a memory 106.

The rendering controller 102 is configured to render lights in a three-dimensional (3D) scene 108 including one or more objects 110. The rendering controller 102 may include suitable logic, circuitry, interfaces, and/or code that is configured to provide access to the 3D scene 108 collectively to a number of viewers. In an example, the 3D scene 108 refers to a 3D virtual environment or a virtual construct (e.g., a virtual model) designed through any suitable 3D modelling technique and computer-assisted drawings (CAD) methods that enable exploration thereof and communications between users through their corresponding virtual characters. Examples of the 3D scene 108 may include but are not limited to, a 3D roller coaster, a 3D haunted house in an entertainment park, an entertainment park, 3D video games, a 3D museum, a 3D city, a school, a factory, any venue, and the like. Further, the one or more objects 110 in the 3D scene 108 are virtual objects imitating real objects that may include but are not limited to a vehicle (e.g., a car), a plurality of vehicles, a plurality of buildings, and the like. Furthermore, the one or more objects 110 affect each scene view as the scene view changes when a viewer changes the position in the 3D scene 108. In an embodiment, the change in position of each viewer leads to a change in the perspective of the one or more objects 110 that affects the scene view of the 3D scene 108. In another embodiment, the change in position of each viewer leads to the appearance of a new object that affects the scene view of the 3D scene 108.

Examples of the rendering controller 102 may include, but are not limited to, a processor, a digital signal processor (DSP), a microprocessor, a microcontroller, a complex instruction set computing (CISC) processor, an application-specific integrated circuit (ASIC) processor, a reduced instruction set computing(RISC) processor, a very long instruction word (VLIW) processor, a state machine, a data processing unit, a graphics processing unit (GPU), and other processors or control circuitry. The communication interface 104 may include suitable logic, circuitry, and/or an interface that is configured to communicate data processed by the rendering controller 102 to the number of viewers. Examples of the communication interface 104 may include but are not limited to a network interface, a computer port, a network socket, a network interface controller (NIC), and any other network interface device. The memory 106 may include suitable logic, circuitry, and/or interfaces that are configured to store data related to the 3D scene 108. Examples of the memory 106 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

Further, each of the one or more objects 110 are associated with a plurality of on-surface reservoirs. In an embodiment, the plurality of on-surface reservoirs corresponds to on-surface-cached reservoirs. Moreover, instead of separately computing all rendered views of the one or more objects 110, the rendering controller 102 is configured to use view-independent, dynamic cache structures that allow sharing of rendering computations to different viewers in the 3D scene 108. In an embodiment, the on-surface reservoirs store computations in the form of caches. The on-surface reservoirs are beneficial to share all view-independent rendering computations to the number of viewers in case of overlapping views, whereas to share view-dependent computations in case of non-overlapping views. The on-surface reservoirs are advantageous to reduce the cost of computation (i.e., the processing time or power consumed by any system on which the rendering is performed) of views for each viewer. In addition, the rendering controller 102 is further configured to provide light transport computation in texture space utilizing resampled importance sampling (RIS) or weighted reservoir sampling (WRS) based on the on-surface caches. In an embodiment, the RIS is a statistical technique used in rendering to calculate lighting and shading effects in the 3D scene 108 with complex geometry and materials. In another embodiment, the WRS is a statistical technique, which reduces the number of samples required during rendering. In the WRS, lighting samples are taken at locations in the 3D scene 108, and the contribution of each sample is weighted according to the importance of each sample in the contribution to form a final image.

In an embodiment, the rendering controller 102 is configured to utilize the WRS and the RIS in the texture space (i.e., surface space) of the one or more objects 110 based on the plurality of on-surface reservoirs to overcome screen-space constraints. The screen-space constraints refer to limitations on what can be displayed on the screen of each viewer. Examples of such limitations may include the resolution of the screen, the size of the viewport, a graphics processing power available to the system in which the screen is configured, and the like. The use of the WRS and the RIS in the texture space enables efficient single and multi-viewer direct and indirect light sampling. The application of the WRS and the RIS in the texture space provides an advantage of avoiding the requirement of the temporal reprojection (e.g., in the case of conventional sampling techniques) and the spatial filtering can be simplified by virtue of operating on the surface of the one or more objects 110 of the 3D scene 108. The plurality of on-surface reservoirs lives directly on the surface of the one or more objects 110 and is used to store statistical numbers. Furthermore, spatiotemporal reuse of samples in the texture space enables several users with several viewpoints to access the data and samples. In other words, if multiple viewers or rays from other light sources hit the same surface point over the one or more objects 110, then reservoir sampling is used to guide light sampling towards the different light sources. In an embodiment, the sources of rays can be multiple viewers, stereo rendering, or rays bouncing around in the 3D scene 108 (e.g., global illumination-path tracing). In an embodiment, the RIS selects samples from one source distribution and generates a weighted subset of samples by using a target probability distribution function, which approximates the integrand of a rendering equation. The rendering equation corresponds to a mathematical expression, which describes the interaction of light emitted from the one or more light sources with the surfaces of the one or more objects 110. In an embodiment, the rendering controller 102 calculates a final radiance of a point on the surface of the one or more objects by integrating the radiance from all incoming directions. The utilization of the RIS based on the on-surface caches is beneficial for solving the problem of the one or more light sources by generating samples from a distribution that approximates an incoming light distribution from the one or more light sources or the product of all the terms used for shading. In an embodiment, the RIS is performed along with the WRS, which is beneficial for the efficient operation of the RIS with a low memory footprint. In the WRS, one light's sample data out of the multiple light sources is kept in a reservoir along with statistical parameters. The reservoir is updated for every frame with new input samples generated with ray tracing. Further, each new sample is either selected or discarded with a probability based on weights.

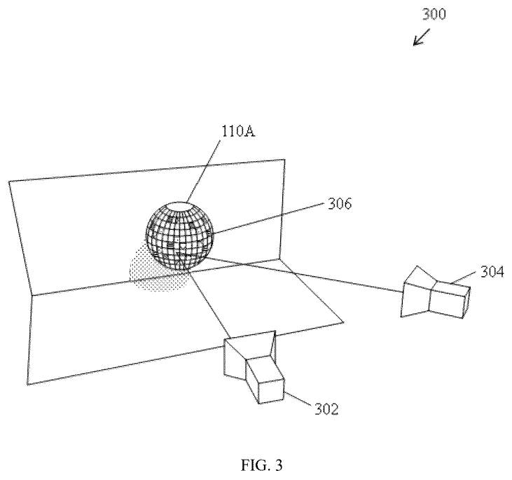

In accordance with an embodiment, an on-surface cache reservoir lives on the surface of 3D objects in on-surface cache textures. In such embodiment, the on-surface cache reservoir includes a light sample point description, RIS weights, the number of seen samples, and the sum of their weights for normalization. In an example, the light sample point description may correspond to triangle index, UV coordinates, and outgoing radiance. In an embodiment, the on-surface cache reservoir data is packed in 3 half 4 data structures that are stored in the on-surface cache textures. For example, the total memory footprint of one reservoir is thus 3*4*2 bytes=24 bytes. In an example, the on-surface cache reservoirs are stored on the surface of objects directly, making any reuse among different viewers impossible, as further shown and described in FIG. 3.

In accordance with an embodiment, the on-surface cache reservoirs enable sampling information to be leveraged independently of an observer, view direction, or direction of a light ray exiting the surface location of the on-surface cache reservoirs. The plurality of on-surface reservoirs is stored on the surface of the one or more objects 110 (i.e., the virtual objects) of the 3D scene 108. In an embodiment, the on-surface cache reservoirs are view-independent data structures, which allows the sampling information to be leveraged independently of the observer and view direction. The advantage of leveraging the sampling information independent of the observer is to avoid the problems of overlapping the views from multiple viewers.

In accordance with an embodiment, the rendering controller 102 is further configured to guide light sampling for direct and indirect illumination estimations based on the on-surface cache reservoirs. In an embodiment, the direct illumination refers to a type of illumination in which the multiple light sources in the 3D scene 108 illuminate the one or more objects 110 directly. The direct illumination is achieved by estimating the light that is received at a surface point from the multiple light sources by sampling the light sources according to the reservoir information, and then determining the way in which the light interacts with the surfaces of the one or more objects 110 in the 3D scene 108. In an embodiment, the indirect illumination refers to a type of illumination that simulates the way light bounces off from the surface of one object amongst the one or more objects 110 and illuminates another object out of the one or more objects 110 in the 3D scene 108. In an embodiment, the rendering controller 102 is configured to guide light sampling for direct & indirect illumination estimations as well as a path guiding. In such an embodiment, the path guiding refers to tracing light paths from the camera towards the multiple light sources while considering bouncing off the one or more objects 110 in the 3D scene 108 and then using an information gathered along the corresponding paths to determine the color of each pixel in a final rendered 2D image. In an embodiment, the on-surface reservoirs are used to guide light sampling from the surface points encountered as rays bounce through the scene.

In accordance with an embodiment, the rendering controller 102 is further configured to reuse data from a single on-surface-space reservoir for computing lighting effects for several viewpoints. The plurality of on-surface reservoirs (i.e., on-surface-space reservoirs) shading allows the reuse of the data from the single on-surface-space reservoir for computing the lighting effects for several view-points. The plurality of on-surface reservoirs is generated for one view and are reused for other views in the 3D scene 108. Furthermore, the sampling process(es) may also be used for other views in the 3D scene 108, which happen in the same virtual scene. In an embodiment, the rendering controller 102 is configured to reuse the on-surface-space reservoirs generated for one view or sampling process to other views or sampling processes in the 3D scene 108. In another embodiment, the frame-less nature of the on-surface space reservoirs is beneficial for sampling and updating reservoirs independently of a rendering frame or viewer. In an embodiment, the rendering controller 102 is configured to perform resampling on the surface of the one or more objects, without any impact of time (i.e., without a frame time). In addition, due to the frameless nature of the on-surface space reservoirs, rays from the one or more light sources are coincided over the one or more objects 110 for resampling without a frame time (i.e., unlike conventional rendering techniques, which require frames with motion vectors). The rendering controller 102 prevents the change of location of the on-surface space reservoir on the one or more objects 110 over a time period, which is beneficial to enable sampling to be performed on any point on the surface of the one or more objects 110.

In accordance with an embodiment, the rendering controller 102 is further configured to access neighboring reservoirs on the surface of an object for the on-surface cache reservoir for resampling leading to efficient sharing of candidate samples on objects. The advantage of accessing the neighboring reservoirs enables a continuous on surface space to utilize the RIS over unseen surrounding points without the need for checking whether the corresponding surrounding points fulfill any depth threshold. Such surrounding points are checked by transmitting a query to the neighboring reservoirs. In an embodiment, the generation and sampling of the on-surface cache reservoirs, which are invisible in all views but guided by the existence of other reservoirs allow for more efficient resampling. In an embodiment, the rendering controller 102 uses different resolutions while storing the on-surface cache reservoirs. In addition, the rendering controller 102 is configured to resample the on-surface cache reservoirs at various resolutions, which is beneficial to efficiently cover different distances on the surfaces of the one or more objects 110. In accordance with an embodiment, the rendering controller 102 is further configured to receive visible texels among all viewers and corresponding cache resolution. In an embodiment, the visible texels are fundamental units of a texture map. In such an embodiment, textures are represented by arrays of visible texels representing a texture space (i.e., similar to arrays of pixels in the case of images). In addition, for each visible texel, the rendering controller 102 is further configured to update the corresponding on-surface cache reservoir using Initial Sampling, Temporal Resampling, and Spatial Resampling. Moreover, during the Initial Sampling, the rendering controller 102 is configured to generate a new random light sample. In accordance with an embodiment, during the Initial Sampling, the rendering controller 102 is configured to receive an initial sample count N, receive texel information and associated geometric data, and create the on-surface cache reservoir. Thereafter, the rendering controller 102 is further configured to generate N initial samples and update the cache reservoir. Furthermore, the rendering controller 102 is further configured to evaluate the visibility of the resulting sample in the cache reservoir and compute the weight of the resulting sample accordingly.

In addition, during the Temporal Resampling, the rendering controller 102 is configured to update a temporal reservoir at the current texel with the new light sample. Furthermore, the rendering controller 102 is configured to read a Temporal Reservoir Cache Texture, and sample the temporal cache texture at the same texel location to get a cached reservoir from a last frame. Thereafter, the rendering controller 102 is configured to combine the last frame cache reservoir and a newly generated reservoir in a new output cache reservoir. Moreover, the rendering controller 102 is configured to recompute the weight of the resulting sample in the output cache reservoir and Write the Temporal Reservoir Cache Texture. Thereafter, the rendering controller 102 is configured to perform Spatial Resampling, such as selecting random neighbor temporal reservoirs and using the selected random neighbor temporal reservoirs to update a current spatial reservoir. Moreover, for each viewer, the rendering controller 102 is configured to sample the spatial reservoir texture at the correct cache resolution and use the reservoir content used for direct lighting shading. In accordance with an embodiment, during the Spatial Resampling, the rendering controller 102 is configured to receive neighbor radius Rₙ, and neighbor count Nₙ and read a Temporal Reservoir Cache Texture. Thereafter, the rendering controller 102 is configured to sample the temporal cache texture to get the newly generated cached temporal reservoir. Moreover, for the number of neighbor samples Nₙ, the rendering controller 102 is configured to generate random texel offset in a Rₙ texel neighborhood and receive a Temporal Reservoir Cache Texture. Thereafter, the rendering controller 102 is configured to sample temporal reservoir cache texture at random neighbor texel for the number of neighbor samples Nₙ. Furthermore, the rendering controller 102 is configured to update current texel temporal reservoir with a neighbor reservoir for the number of neighbor samples Nₙ. Finally, the rendering controller 102 is configured to evaluate the visibility of resulting sample in the current cached reservoir for the number of neighbor samples Nₙ. In addition, the rendering controller 102 is configured to compute the weight of the resulting sample accordingly and write a Spatial Reservoir Cache Texture.

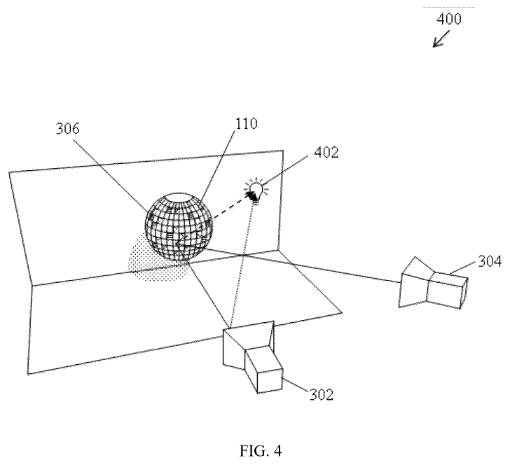

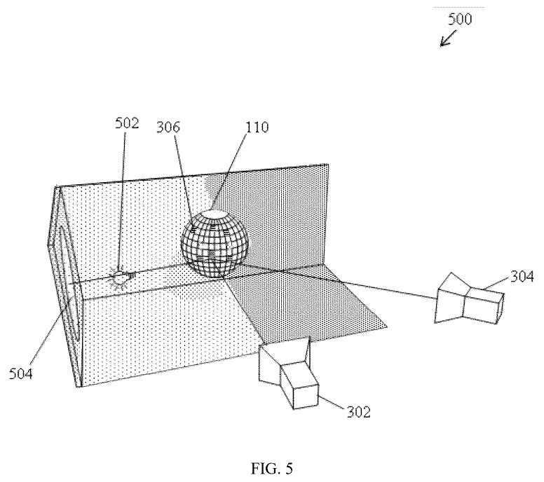

In accordance with an embodiment, during Reservoir Shading, the rendering controller 102 is further configured to receive a Spatial Reservoir Cache Texture for each viewer and for each visible texel. Moreover, the rendering controller 102 is further configured to receive a cached spatial reservoir to get the associated light sample's data for each viewer and for each visible texel. Thereafter, the rendering controller 102 is configured to compute outgoing radiance by plugging this data in the rendering equation for each viewer and for each visible texel. Furthermore, the rendering controller 102 is configured to determine the weight based on the cached reservoir's weight and output pixel color value for each viewer and for each visible texel, as further shown and described in FIG. 4.

The rendering controller 102 is used to render the lights in the 3D scene 108 that include the one or more objects 110, such as by applying the RIS or the WRS on the on-surface reservoirs to enable efficient single and multi-viewer direct and indirect light sampling. The rendering controller 102 provides on-surface weighted reservoir resampling (i.e., ‘timeless’ resampling) for sharing lighting computations across time and space in multi-viewer scenarios. In other words, the rendering controller 102 shoots rays for the on-surface weighted reservoir resampling without a frame time, as the on-surface-space reservoir does not change location over time, and sampling can happen at any point. In addition, the rendering controller 102 is configured to store the on-surface reservoirs in on-surface caches, such as the plurality of on-surface reservoirs living directly on the surface of the objects. Beneficially as compared to in screen space, the continuous on-surface-space reservoir allows to perform the RIS with unseen surrounding surface points. The rendering controller 102 can directly query neighboring reservoirs. Moreover, if multiple viewers or rays from other different sources hit the same surface point, then the reservoir sampling can be used to guide light sampling from the location. Therefore, there is no need for checking whether the surrounding points fulfill any depth threshold, and the like.

FIG. 2 is a flowchart of a method for a rendering controller configured to render lights in a 3D scene, in accordance with an embodiment of the present disclosure. FIG. 2 is described in conjunction with the FIG. 1. With reference to FIG. 2, there is shown a flowchart of a method 200 for the rendering controller 102 (of FIG. 1) configured to render lights in the 3D scene 108 (of FIG. 1). The method 200 includes operations 202 to 206

The method 200 for the rendering controller 102 configured to render lights in the 3D scene includes one or more objects 110 (of FIG. 1). The one or more objects 110 in the 3D scene 108 are virtual objects in the 3D virtual environment, which imitate real objects in the real environment. The examples of the one or more objects 110 may include, but are not limited to, a plurality of vehicles, a plurality of buildings, a plurality of trees, and the like. Further, each object of the one or more objects 110 are associated with a plurality of on surface reservoirs. In an embodiment, the plurality of on-surface reservoirs are on-surface-cached reservoirs. In an embodiment, the plurality of on surface reservoirs store computations in the form of caches. The plurality of on-surface reservoirs are beneficial to share all view-independent rendering computations to a number of viewers in case of overlapping views, whereas to share view-dependent computations in case of non-overlapping views. The plurality of on surface reservoirs are advantageous to reduce the cost of computation (i.e., the processing time or power consumed by any system on which the rendering is performed) for generating views for each viewer out of the multiple viewers.

At operation 202, the method 200 includes allocating the on-surface/texture space reservoirs. In other words, the method 200 allocates the plurality of on-surface reservoirs 306 over the surface of the one or more objects 110. In accordance with an embodiment, the on-surface cache reservoirs associated with the one or more objects 110 in the method 200 enable sampling information to be leveraged independently of an observer, view direction, or direction of a light ray exiting a surface location of the on-surface cache reservoirs. At operation 204, the method 200 includes updating the plurality of on-surface reservoirs 306 using the resampled importance sampling (RIS) and weighted reservoir sampling (WRS). In an embodiment, the RIS is a statistical technique used in 3D rendering to calculate lighting and shading effects in the 3D scene 108 with complex geometry and materials. In another embodiment, the WRS is a statistical technique, which reduces the number of samples required during rendering. In WRS, lighting samples are taken at locations in the 3D scene 108, and the contribution of each sample is weighted according to the importance of each sample in the contribution to form a final image. At operation 206, the method 200 includes sampling of the plurality of on-surface reservoirs 306. In accordance with an embodiment, the on-surface cache reservoirs include light sample point description, RIS weights, the number of seen samples, and the sum of their weights for normalization. The method 200 provides light transport computation in texture space utilizing RIS or WRS based on the on-surface caches.

In accordance with an embodiment, the rendering controller 102 is further configured for guide light sampling for direct & indirect illumination estimations based on the on-surface cache reservoirs. In an embodiment, the direct illumination refers to a type of illumination that simulates the way the multiple light sources in the 3D scene 108 illuminate the one or more objects 110 directly. The direct illumination is achieved by calculating the light that is emitted from the multiple light sources and then tracing the path of the light to determine the way in which the light interacts with the surfaces of the one or more objects 110 in the 3D scene 108. In an embodiment, the indirect illumination refers to a type of illumination that simulates the way light bounces off from the surface of one object amongst the one or more objects 110 and illuminates another object out of the one or more objects 110 in the 3D scene 108. In an embodiment, the rendering controller 102 is configured to guide light sampling for direct & indirect illumination estimations as well as a path guiding. In such an embodiment, the path guiding refers to tracing light paths from the multiple light sources to a camera, and then using an information gathered along the corresponding paths to determine the color of each pixel in a final rendered 2D image.

In accordance with an embodiment, the rendering controller 102 is further configured to reuse data from a single on-surface-space reservoir for computing lighting effects for one or more viewpoints. In an embodiment, the one or more viewpoints refer to the locations of each viewer from the multiple viewers viewing the one or more objects 110. Each viewer possesses a corresponding viewpoint. In accordance with an embodiment, the rendering controller 102 is further configured to access neighboring reservoirs on the surface of an object for the on-surface cache reservoir for resampling leading to efficient sharing of candidate samples on objects. Further, in accordance with an embodiment, the rendering controller 102 is further configured to receive visible texels among all viewers from the multiple viewers and corresponding cache resolution. Further, the rendering controller 102 is configured to update the corresponding on-surface cache reservoir for each visible texel. The rendering controller 102 is configured to generate a new random light sample during the initial sampling. In accordance with an embodiment, the rendering controller 102 is configured to receive an initial sample count N and receive texel information and associated geometric data to create the on-surface cache reservoir during the initial sampling. In such embodiment, the rendering controller 102 is configured to generate N initial samples and update the cache reservoir. Moreover, the rendering controller 102 is configured to evaluate visibility of the resulting sample in the cache reservoir and compute the weight of the resulting sample accordingly.

Further, the method 200 includes, updating a temporal reservoir at the current texel with the new light sample during the temporal resampling, by the rendering controller 102. In accordance with an embodiment, the method 200 includes, reading a temporal reservoir cache texture during the temporal resampling, by the rendering controller 102. Furthermore, the rendering controller 102 is configured to sample the temporal cache texture at the same texel location to get the cached reservoir from the last frame and combine the last frame cache reservoir and newly generated reservoir in a new output cache reservoir. In addition, the rendering controller 102 is configured to recompute the weight of the resulting sample in the output cache reservoir and write a temporal reservoir cache texture. Further, the rendering controller 102 is further configured to select random neighbor temporal reservoirs and use the selected random neighbor temporal reservoirs to update a current spatial reservoir during the spatial resampling.

In accordance with an embodiment, the rendering controller 102 is configured to receive a neighbor radius Rₙ, and a neighbor count Nₙ to read a temporal reservoir cache texture and sample the temporal cache texture to get newly generated cached temporal reservoir during the spatial resampling. In case of the number of neighbor samples Nₙ, the rendering controller 102 in the method 200 is configured to generate random texel offset in a Rₙ texel neighborhood, receive a temporal reservoir cache texture, and sample temporal reservoir cache texture at random neighbor texel during the spatial sampling. Furthermore, the rendering controller 102 is configured to update current texel temporal reservoir with neighbor reservoir and evaluate the visibility of resulting sample in the current cached reservoir and compute the weight of the resulting sample accordingly. After computing the weight, the method 200 includes, writing a spatial reservoir cache texture, by the rendering controller 102. In accordance with an embodiment, the rendering controller 102 in the method 200 is configured to sample the spatial reservoir texture at the correct cache resolution and use the reservoir content used for direct lighting shading. In accordance with an embodiment, the rendering controller 102 in the method 200 is configured to receive a spatial reservoir cache texture for each visible texel corresponding to each viewer of the multiple viewers and receive a cached spatial reservoir to get the associated light sample's data. In such embodiment, compute outgoing radiance by plugging this data in the rendering equation and determine the weight based on the cached reservoir's weight and output pixel color value.

There is provided a computer program product comprising program instructions for performing the method 200, when executed by one or more processors in a rendering controller system. The computer program product is implemented as an algorithm, embedded in a software stored in the non-transitory computer-readable storage medium having program instructions stored thereon, the program instructions being executable by the one or more processors in the rendering controller system to execute the method 200. The non-transitory computer-readable storage means may include, but are not limited to, an electronic storage device, a magnetic storage device, an optical storage device, an electromagnetic storage device, a semiconductor storage device, or any suitable combination of the foregoing. Examples of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

FIG. 3 is a diagram that depict exemplary scenario of screen-space reservoirs and surface space reservoirs in the on-surface weighted reservoir resampling (OSWRR) technique respectively, in accordance with different embodiments of the present disclosure. FIG. 3 is described in conjunction with elements from FIGS. 1 and 2. With reference to FIG. 3, there is shown a diagram 300 that depicts surface space reservoirs in the OSWRR technique.

In an embodiment, in the case of the OSWRR technique (as shown in FIG. 3), two viewers out of the multiple viewers, such as a first viewer 302 and a second viewer 304 are viewing towards an object out of the one or more objects 110. In an embodiment, in the OSWRR technique configured in the rendering controller 102 (of FIG. 1), on surface cached reservoirs 306 are stored directly on the surface of the object out of the one or more objects 110 through the on-surface cache textures. Due to the position of the on surface cached reservoirs 306 on the surface of the object, the sampling information for rendering computation for each viewer out of the multiple viewers is leveraged independent of the viewers and corresponding view directions. In addition, the on surface cached reservoirs 306 on the object out of the one or more objects 110 (as shown in FIG. 3) are independent of the screen space of each viewer, which is beneficial to overcome the screen space constraints and enable efficient light sampling for direct and indirect illumination from multi-viewer applications. Thus, the OSWRR technique configured in the rendering controller 102 is beneficial to reduce computation costs to generate rendered views as compared to the conventional methods. In addition, the OSWRR technique allows to sample across different resolutions. In an example, MIP chains of reservoirs are generated and can distribute samples across scales easily and smoothly transition between MIP levels. Moreover, the OSWRR technique can be used by any source that desires to sample the on-surface location, therefore the OSWRR technique can be used for various applications, such as multi-viewer or recursive ray/path tracing.

FIG. 4 is a diagram that depicts an exemplary scenario of the on-surface cache reservoirs in the OSWRR technique for performing direct lighting estimation, in accordance with an embodiment of the present disclosure. FIG. 4 is described in conjunction with FIGS. 1 and 3. With reference to FIG. 4, there is shown an exemplary diagram 400 that depicts an exemplary scenario of the on surface cached reservoirs 306 (of FIG. 3) in the OSWRR technique for performing direct lighting estimation.

In direct lighting, an object out of the one or more objects 110 (of FIG. 1) is directly illuminated by one or more virtual light sources to provide a realistic view of the object in the final rendered image. In an example, the object out of the one or more objects 110 is directly illuminated by a light source 402. The light source 402 is a virtual light source, which is used by the rendering controller 102 (of FIG. 1) to simulate the behavior of the object during the interaction of light to compute the rendering of the object. In such an example, the object is viewed by the first viewer 302 (of FIG. 3) and the second viewer 304 (of FIG. 3). During the rendering of the object, the rays from the first viewer 302 and the second viewer 304, such as virtual rays are cast over the object the first viewer 302 and the second viewer 304 and the paths of the virtual rays are traced to form rendered images for each of the first viewer 302 and the second viewer 304. In direct lighting estimation, the rendering controller 102 stimulates the path from which the light from the light source 402 travels toward the object. Further, the rendering controller 102 combines the path of the virtual rays and the path of the light from the light source 402 to calculate the amount of light reflected from the surface of the object. In the OSWRR technique, the rendering controller 102 reads the spatial reservoir cache texture for each viewer of the first viewer 302 and the second viewer 304 and retrieves the on surface cached reservoirs 306 to get an associated light sample's data corresponding to the light source 402. Furthermore, the rendering controller 102 computes the reflected light (i.e., outgoing radiance) from the object by integrating the light sample's data into the rendering equation. In an embodiment, the rendering equation expresses an amount of light leaving a point on the surface of the object in a particular direction by summing all incoming light in all directions. Further, the rendering controller 102 calculates weights of the on surface cached reservoirs 306 and determines a color value for each pixel in an output rendered image. The OSWRR technique configured in the rendering controller 102 is advantageous for efficient rendering computation by storing lighting samples in the on surface cached reservoirs 306 and reusing the lighting samples for consequent computations.

FIG. 5 is an exemplary diagram that depicts an exemplary scenario of an application of OSWRR technique for global illumination estimation, in accordance with an embodiment of this disclosure. FIG. 5 is described in conjunction with FIGS. 1, 3, and 4. With reference to FIG. 5, there is shown an exemplary diagram 500 that depicts an exemplary scenario of the application of the OSWRR technique for global illumination estimation.

In an embodiment, the global illumination includes indirect illumination. In an embodiment, the global illumination refers to the illumination of the object out of the one or more objects 110 due to the light, which has bounced or reflected from surfaces other than the surfaces of the object. The global illumination involves calculation and simulation of the way light interacts with the surfaces of the object in a more realistic way to produce softer shadows and more subtle variations in lighting. Beneficially as compared to conventional approaches, the rendering controller 102 (of FIG. 1) applies the OSWRR technique to estimate the global illumination by storing lighting samples in the on surface cached reservoirs 306 and reusing the lighting samples for consecutive computations, thereby reducing the complexity of computations, even in case of multiple and dynamic light sources.

In an exemplary scenario (as shown in FIG. 5), an object out of the one or more objects 110 is illuminated indirectly by a primary light source 502 (e.g., a virtual light source). The primary light source 502 illuminates a surface other than the corresponding object and the light reflected from the corresponding surfaces acts as a secondary light source 504, which illuminates the corresponding object. In such an example, the associated light sample for the object is the secondary light source 504. Moreover, the object is viewed by the first viewer 302 and the second viewer 304. In operation, the rendering controller 102 casts virtual rays from the first viewer 302 and the second viewer 304, and the paths of the virtual rays are traced to form rendered images of the object for each of the first viewer 302 and the second viewer 304. In the OSWRR technique, the rendering controller 102 reads the spatial reservoir cache texture for each viewer of the first viewer 302 and the second viewer 304 and retrieves the on surface cached reservoirs 306 (of FIG. 3) to get an associated light sample data corresponding to the secondary light source 504. The application of the OSWRR technique for the global illumination estimation is different from the application of the OSWRR technique for the direct illumination estimation with respect to the nature of light samples stored in the on surface cached reservoirs 306. In case of direct illumination, the rendering controller 102 is configured to store the samples of the primary light source 502 in the on surface cached reservoirs 306, whereas, in case of global (i.e., indirect) illumination, the rendering controller 102 is configured to store the light samples, which are associated with the secondary light source 504. The application of the OSWRR technique to the global illumination estimation is beneficial to leverage the same statistical tools and the same data structures (i.e., the on surface cached reservoirs 306) to solve direct lighting estimation problems, thereby efficiently computing the effects of both direct and indirect lighting on any object out of the one or more objects.

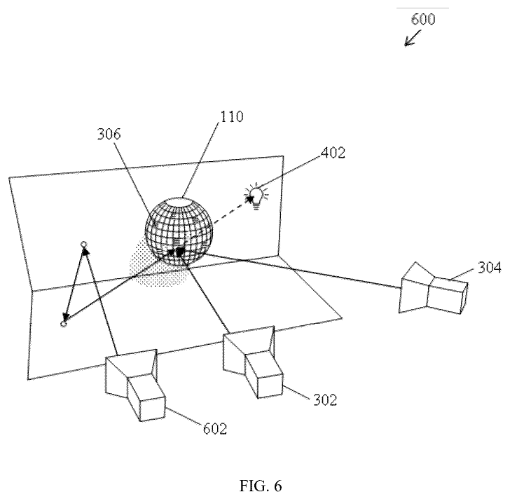

FIG. 6 shows an exemplary diagram that depicts an exemplary scenario of an application of the OSWRR technique to path guiding, in accordance with an embodiment of this disclosure. FIG. 6 is described in conjunction with the elements of the FIGS. 1 to 5. With reference to FIG. 6, there is shown an exemplary diagram 600 that depicts an exemplary scenario of the application of the OSWRR technique to path guiding.

In an exemplary scenario, an object out of the one or more objects 110 is illuminated directly by the light source 402 (of FIG. 4). Further, the corresponding object is viewed by three viewers, such as the first viewer 302, the second viewer 304, and a third viewer 602. Moreover, the rendering controller 102 (of FIG. 1) casts virtual rays from the first viewer 302, the second viewer 304, and the third viewer 602. The virtual rays from the first viewer 302 and the second viewer 304 are reflected towards the light source 402, whereas the virtual rays from the third viewer are reflected from surfaces other than the surface of the on surface cached reservoirs 306 before reaching towards the light source 402. Moreover, the first viewer 302 and the second viewer 304 view the object under influence of a direct lighting received from the light source 402, whereas the third viewer 602 views the object under influence of an indirect lighting received from the light source 402. The on surface cached reservoirs 306 store light samples in the form of a cache. Due to the application of the OSWRR technique to the path guiding, the light samples from the on surface cached reservoirs 306 are shared between the first viewer 302, the second viewer 304, and the third viewer 602 for direct light estimation. Furthermore, the OSWRR technique enables the rendering controller 102 to use the on surface cached reservoirs 306 to terminate a recursive light path that goes through the 3D scene when computing the indirect lighting. In case of global (i.e., indirect) illumination, the rendering controller 102 is configured to terminate the paths of the virtual rays from the first viewer 302, the second viewer 304, and the third viewer 602 at the light source 402 to enable each path to carry as much information regarding the object as possible. By combining the path guiding technique with the OSWRR technique, the rendering controller 102 is configured to implement a dynamic structure that encodes light sampling data, which can be leveraged to compute direct lighting shading as well as to terminate indirect light paths at sampled light sources for indirect lighting.

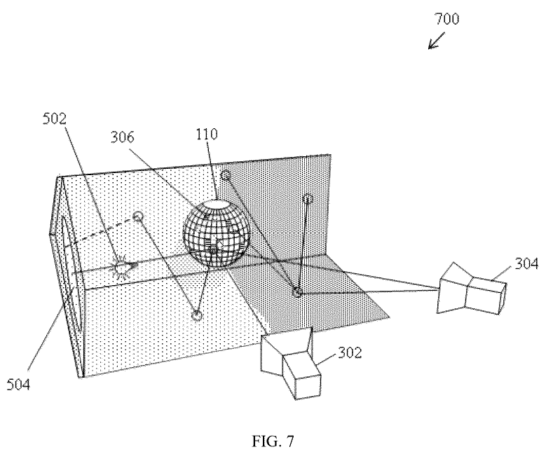

FIG. 7 shows an exemplary diagram that depicts an exemplary scenario of an application of the OSWRR for multiple bounce global illumination computation, in accordance with an embodiment of this disclosure. FIG. 7 is described in conjunction with the elements of FIGS. 1 to 6. With reference to FIG. 7, there is shown an exemplary diagram 700 that depicts an exemplary scenario of the application of the OSWRR for multiple bounce global illumination.

In an embodiment, the multiple bounce global illumination refers to the indirect illumination of an object out of the one or more objects 110 by the secondary light source 504 (of FIG. 5) in which the light from the secondary light source 504 is bounced several times from the surfaces other than the surface of the object. During estimation of the multiple bounce global illumination, the bounced light from multiple surfaces is traced recursively. When a ray of light intersects with a surface, the ray of light gets reflected or refracted, and a new ray is produced in the direction of the reflection or refraction. The reflections or refractions are repeated until a maximum number of bounces is reached, or the light intensity of the secondary light source 504 falls below a certain threshold. In an embodiment, the secondary light source 504 is generated due to illumination by the primary light source 502 (of FIG. 5). In such case, the on surface cached reservoirs 306 (of FIG. 3) generated by the rendering controller 102 generate multiple bounces for global illumination. The storage of the lighting samples corresponding to the global illumination in the on surface cached reservoirs 306 is beneficial to reconstruct complex and expansive light paths by linking the on surface cached reservoirs 306 with each other. In a first case, the rendering controller 102 is configured to reconnect to other resampled (e.g., which are meaningful) samples to generate multiple bounce global illumination. In the first case, the rendering controller 102 is configured to reconstruct the light path from the on surface cached reservoirs 306 for computing the multiple bounce global illumination estimation, which enables the rendering controller 102 to reuse lighting samples that are occluded or out of frame for path construction for one viewer out of the first viewer 302 and the second viewer 304. In an example, the lighting sample used in the first viewer 302 is occluded for the second viewer 304 and can be reused to compute the global illumination estimation. In a second case, the OSWRR technique configured in the rendering controller 102 increases sample count when computing a single bounce global illumination at a location on the object. In an embodiment, the rendering controller 102 is configured to average the lighting samples in case of multiple single bounce global illumination by using the on surface cached reservoirs 306.

A skilled artisan may modify the embodiments of the present disclosure described in the foregoing without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. A rendering controller comprises:
a processor; and
memory coupled with the processor, wherein the processor is configured to execute instruction stored in the memory to:
render lights in a three-dimensional (3D) scene comprising one or more objects associated with a plurality of on-surface cache reservoirs; and
provide light transport computation in texture space utilizing resampled importance sampling (RIS) or weighted reservoir sampling (WRS) based on the plurality of on-surface cache reservoirs.

2. The rendering controller according to claim 1, wherein the on-surface cache reservoirs enable sampling information to be leveraged independently of observer, view direction, or direction of a light ray exiting a surface location of the on-surface cache reservoirs.

3. The rendering controller according to claim 1, wherein the processor is further configured to execute instruction stored in the memory to:
guide light sampling for direct & indirect illumination estimations based on the on-surface cache reservoirs.

4. The rendering controller according to claim 1, wherein the processor is further configured to execute instruction stored in the memory to:
reuse data from a single on-surface-space reservoir for computing lighting effects for several viewpoints.

5. The rendering controller according to claim 1, wherein the processor is further configured to execute instruction stored in the memory to:
access neighboring reservoirs on the surface of an object for the on-surface cache reservoir for resampling leading to efficient sharing of candidate samples on objects.

6. The rendering controller according to claim 1, wherein the processor is further configured to execute instruction stored in the memory to:
receive visible texels among all viewers and corresponding cache resolution;
for each visible texel, update the corresponding on-surface cache reservoir by:
generating a new random light sample for an initial sampling;
updating a temporal reservoir at a current texel with the new light sample for the temporal resampling;
selecting random neighbor temporal reservoirs for spatial resampling;
use the selected random neighbor temporal reservoirs to update a current spatial reservoir; and
sample spatial reservoir texture for each viewer at a correct cache resolution and use reservoir content for direct lighting shading.

7. The rendering controller according to claim 6, wherein the processor is further configured to execute instruction stored in the memory, for the initial sampling, to:
receive an initial sample count N;
receive texel information and associated geometric data;
create an on-surface cache reservoir;
generate N initial samples and update the on-surface cache reservoir;
evaluate visibility of resulting sample in the on-surface cache reservoir; and
compute weight of the resulting sample accordingly.

8. The rendering controller according to claim 1, wherein the processor is further configured to execute instruction stored in the memory, for temporal resampling, to:
read a temporal Reservoir Cache Texture;
sample the temporal cache texture at the same texel location to get cached reservoir from last frame;
combine the last frame cache reservoir and newly generated reservoir in a new output cache reservoir;
recompute a weight of resulting sample in the new output cache reservoir; and
write a Temporal Reservoir Cache Texture.

9. The rendering controller according to claim 1, wherein the processor is further configured to execute instruction stored in the memory, for spatial resampling, to:
receive neighbor radius Rn, and neighbor count Nn;
read a Temporal Reservoir Cache Texture;
sample the temporal cache texture to get newly generated cached temporal reservoir; and
for a number of neighbor samples Nn;
generate random texel offset in a Rn texel neighborhood,
receive a Temporal Reservoir Cache Texture,
sample temporal reservoir cache texture at random neighbor texel,
update current texel temporal reservoir with neighbor reservoir,
evaluate visibility of resulting sample in a current cached reservoir and compute weight of the resulting sample accordingly, and
write a Spatial Reservoir Cache Texture.

10. The rendering controller according to claim 1, wherein the processor is further configured to execute instruction stored in the memory, for reservoir shading for each viewer and each visible texel, to:
receive a Spatial Reservoir Cache Texture;
receive cached spatial reservoir to obtain associated light sample's data;
compute outgoing radiance by plugging this data in a rendering equation; and
determine a weight based on a cached reservoir's weight and output pixel color value.

11. The rendering controller according to claim 1, wherein an on-surface cache reservoir live on the surface of 3D objects in on-surface cache textures.

12. The rendering controller according to claim 1, wherein an on-surface cache reservoir comprises a light sample point description, RIS weights, a number of seen samples and a sum of their weights for normalization.

13. A method, comprising:
rendering lights in a three-dimensional (3D) scene comprising one or more objects associated with a plurality of on-surface cache reservoirs; and
providing light transport computation in texture space utilizing resampled importance sampling (RIS), or weighted reservoir sampling (WRS) based on the on-surface caches.

14. The method according to claim 13, wherein the on-surface cache reservoirs enable sampling information to be leveraged independently of observer, view direction, or direction of a light ray exiting a surface location of the on-surface cache reservoirs.

15. The method according to claim 13, further comprising:
guiding light sampling for direct & indirect illumination estimations based on the on-surface cache reservoirs.

16. The method according to claim 13, further comprising:
reusing data from a single on-surface-space reservoir for computing lighting effects for several viewpoints.

17. The method according to claim 13, further comprising:
accessing neighboring reservoirs on the surface of an object for the on-surface cache reservoir for resampling leading to efficient sharing of candidate samples on objects.

18. The method according to claim 13, wherein an on-surface cache reservoir live on the surface of 3D objects in on-surface cache textures.

19. The method according to claim 13, wherein an on-surface cache reservoir comprises a light sample point description, RIS weights, a number of seen samples and a sum of their weights for normalization.

20. A computer-readable storage medium, storing computer-executable instructions, wherein when the instructions are run by a computing device cluster which comprises at least one computing device, the computing device cluster is enabled to:
render lights in a three-dimensional (3D) scene comprising one or more objects, wherein each object is associated with a plurality of on-surface cache reservoirs; and
provide light transport computation in texture space utilizing resampled importance sampling (RIS) or weighted reservoir sampling (WRS) based on the on-surface caches.
